(19) United States
(12) Patent Application Publication
(10) Pub. No.: US 2008/0117438 A1
(43) Pub. Date: May 22, 2008

(54) SYSTEM AND METHOD FOR OBJECT INSPECTION USING RELIEF DETERMINATION

(75) Inventors: Benoit Quirion, Boucherville (CA); Yan Duval, Beaconsfield (CA); Michel Cantin, St-Lambert (CA)

Correspondence Address: BERESKIN AND PARR, 40 KING STREET WEST, BOX 401, TORONTO, ON, M5H 3Y2, omitted

(73) Assignee: SOLVISION INC., Boucherville (CA)

(21) Appl. No.: 11/560,694

(22) Filed: Nov. 16, 2006

(51) Int. Cl. G01B 11/24

(52) U.S. Cl. 356/610

(57) ABSTRACT

Phase profilometry inspection system has a pattern projection assembly, a detection assembly imaging a plurality of first light intensity patterns on the object and determining a first height of the object, and an absolute object height determination unit combining said first height with at least one second object height measurement to provides absolute height determination of desired points of said object. The first height is determined within an order of said first light intensity pattern and does not resolve absolute height. The second object height measurement can be done also by projecting a light intensity pattern of a lower spatial frequency than the first patterns.

### TECHNICAL FIELD

The described embodiments relate to methods and systems for object inspection using relief determination, as well as product manufacturing using such inspection. In particular, the methods and systems employ projection of modulated intensity patterns onto the object to determine a relief of the object.

### BACKGROUND

High-speed optical image acquisition systems are used in a variety of environments to analyze the physical characteristics of one or more targets. Generally, such systems include an image acquisition system, such as a camera, that can acquire one or more images of the target. The images are then analyzed to assess the target.

Phase profilometry inspection systems are currently used to inspect three-dimensional aspects of target surfaces. The concept of phase profilometry is relatively simple. A pattern or series of patterns of structured light are projected upon a target at an angle relative to the direction of an observer. The reflected pattern is distorted relative to the incident pattern as a function of the object's shape. Knowledge of the system geometry and analysis of the reflected pattern, detected as one or more object images, can provide a map of the object in three dimensions.

Generally, phase profilometry systems employ a source of structured, patterned light, optics for directing the light onto a three-dimensional object an image sensor, such as a camera, for sensing an image of that light as it is scattered, reflected or otherwise modified by its interaction with the three-dimensional object.

Phase profilometry systems rely on relief determination by measuring the phase differences between light reflected from the object under inspection and from a reference object and determining the height of the object at each point based on the phase differences. An example of phase profilometry is illustrated in FIG. 1, in which a grating projection is illustrated to be angularly incident on an object and reference surface. The grating projection is directed to the object and reference surface at the same angle, but at different times.

One difficulty associated with phase profilometry systems is that they generally cannot discern the difference between phase differences, and hence object height, separated by increments of one period. Thus, the object height measurement range is limited to heights corresponding to between 0 and 2π of the light period. This can make it difficult to determine the true relief of the object.

It is desired to address or ameliorate one or more shortcomings or disadvantages associated with relief determination using phase profilometry.

### SUMMARY

According to some embodiments of the invention, a method of manufacturing a product comprising an object includes inspecting the object including determining a relief of the object and rejecting or accepting the product using the relief, the determining the relief comprising combining a first object height determination resulting from a projection and imaging of a plurality of first light intensity patterns onto the object, each first light intensity pattern being shifted with respect to each other first light intensity pattern and modulated by a first modulation frequency, wherein the first object height determination does not resolve absolute height, with a second object height determination, wherein the combining provides absolute height determination of desired points of the object.

The determining the relief comprises in some embodiments the following steps:
a) projecting the plurality of first light intensity patterns onto the object;
b) capturing first reflected light intensities reflected from the object for each projected first light intensity pattern;
c) determining for each of at least some pixels of an image of the object a first height of the object based on reference information and the first reflected light intensities;
d) projecting at least one second light intensity pattern onto the object, the at least one second light intensity pattern being modulated by a second modulation frequency different from the first modulation frequency;
e) capturing second reflected light intensities reflected from the object for each projected second light intensity pattern;
f) determining for at least one of the at least some pixels a second height based on the reference information and the second reflected light intensities;
g) determining a relief of the object based on the first and second heights for the at least some pixels.

In some embodiments, the second height is determined for all of the at least some pixels, and the second modulation frequency is less than the first modulation frequency. The second modulation frequency can be selected to allow for absolute height determination while the first modulation can be selected to allow for precision height determination.

The second light intensity pattern can be projected simultaneously with the first light intensity pattern, the second light intensity pattern remaining in the same position while the first light intensity pattern is shifted, steps (b) and (e) are performed together, and step (f) comprises combining intensity values to remove a variation due to the first modulation frequency and determining an absolute height of the object from a phase of the second light intensity pattern.

In some embodiments, the plurality of first light intensity patterns comprise at least three first light intensity patterns, and the at least one second light intensity pattern comprises one intensity pattern, the second height being determined using object reflectivity parameters determined from the at least three first light intensity patterns.

In other embodiments, the second light intensity pattern is a step function comprising one or more lines or dots, and step (c) mentioned above comprises establishing an object topology jump threshold between neighboring pixels less than one half of one phase order of the first light intensity pattern, determining when the first height crosses a phase order of the first light intensity pattern from one of the at least some pixels to another, adding to the first height of the object a phase order value, and step (g) comprises adjusting the first height by an absolute height value determined in step (f).

In some embodiments, the second height is determined for all of the at least some pixels, and steps a) and d) comprise projecting the first and second light intensity patterns onto the object from the same position and at the same angle.

In some embodiments, step a) comprises projecting the first light intensity patterns onto the object at a first angle and step d) comprises projecting the second light intensity patterns onto the object at a second angle different from the first angle.

In some embodiments, step a) comprises projecting the first light intensity patterns onto the object from a first position and step d) comprises projecting the second light intensity patterns onto the object from a second position different from the first position.

The first and second modulation frequencies may differ by at least an order of magnitude, and in other embodiments, by less than an order of magnitude, for example by less than 40%.

The second height determination may be non-optical, such as by ultrasound or by mechanical means like CMM.

The first light intensity patterns may also comprise at least two patterns projected simultaneously with different colors and imaged simultaneously with a color imaging system.

The first light intensity patterns may be projected using a digital image projector.

In some embodiments of the invention, there is provided a phase profilometry inspection system comprising:

a pattern projection assembly projecting a plurality of first light intensity patterns onto an object, each first light intensity pattern being shifted with respect to each other first light intensity pattern and modulated by a first modulation frequency;

a detection assembly imaging the plurality of first light intensity patterns on the object and determining a first height of the object, wherein the first height is determined within an order of the first light intensity pattern and does not resolve absolute height; and

an absolute object height determination unit combining the first height with at least one second object height measurement to provides absolute height determination of desired points of the object.

### BRIEF DESCRIPTION OF THE DRAWINGS

Embodiments are described in further detail below, by way of example, with reference to the accompanying drawings, in which:

FIG. 1 is a schematic representation of object relief determination using phase profilometry;

FIG. 2A is an example graph of object height variation relative to phase difference in which the object fits within the phase range of 0 to 2π;

FIG. 2B is a further graph of object height variation relative to phase difference, illustrating the 2π range limit for phase profilometry, in which the object is twice the height afforded by the fringe pattern;

FIG. 2C is a schematic graph for illustration purposes of phase as a function of one dimension of the object for an example inclined object phase, where the phase scale is much greater than the object height range, thus all phase measurements relevant to object measurement are scaled by about 0.4π, corresponding to about 40 μm;

FIG. 2D is a schematic graph similar to FIG. 2C, in which the phase scale is much smaller than the object height range, where the range of 0 to 2π is equivalent to about 9 μm;

FIG. 2E is a schematic graph similar to FIG. 2D, in which the phase scale is such that the range of 0 to 2π is equivalent to about 11 μm;

FIG. 3 is a schematic diagram of a projection and detection system for fast moiré interferometry;

FIG. 4 is a block diagram of an object inspection system utilizing the projection and detection system of FIG. 3;

FIG. 5 is a flowchart of a method of object inspection using relief determination;

FIG. 6 is a flowchart of a method of relief determination using fast moiré interferometry; and

FIG. 7 is a flowchart of an example of the method of FIG. 6.

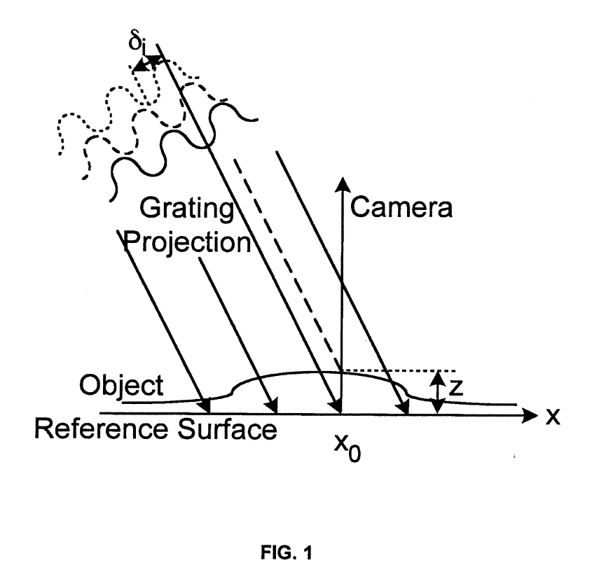

### DETAILED DESCRIPTION

The described embodiments relate generally to methods and systems for relief determination within the context of object inspection during a product manufacturing process. The relief of the object under inspection is determined using a form of phase profilometry described herein as Moiré Interferometry. Further, certain embodiments relate to systems for determining the relief of an object independently of the use made of the determined relief information.

By way of introduction, principles of Moiré Interferometry are described below, following which application of these principles to the described embodiments is described by way of example.

Because of the angle between the projection and detection axes, the intensity data of the reflection of a projected intensity pattern varies both in the horizontal and vertical directions. In general, the intensity of sinusoidally varying projected fringe patterns can be described as:

I(x,y)=R(x,y)·[1+M(x,y)·Cos(kₓ·x+k_{y}·y+k_{z}(x,y)+δᵢ)] (1)

where I(x,y) is the light intensity at the target coordinates {x,y} on the object under inspection, R(x,y) is a reflectivity function proportional to the object reflectance, M(x,y) is a fringe contrast function and kₓ, k_{y} and k_{z} mare the fringe spatial frequencies near the target.

While the term “fringe pattern” is used because the source of the spatial intensity pattern can be caused by interference of electromagnetic wave fronts, it can also be caused by superposition of periodic patterns, namely Moiré interference, or by projection through a mask. A fringe pattern can be projected with a light source of non-coherent light. This projection mask can be physically moved for shifting of the pattern on the object using, for example, a piezoelectric actuator.

In some embodiments, the projection light source is a video projector having sufficient resolution, such as a digital light processing (DLP) projector, Liquid Crystal on Silicon (LCOS) or LCD projector. The choice of projector is a function of desired light intensity and image sharpness on the object. A DLP projector has been found to provide the desired properties of brightness, sharpness and resolution. Using a digital projector, pattern shifts and changes, and possibly color changes, are easily performed by digital control instead of electromechanical control.

Color may also be used to obtain a plurality of pattern projection images simultaneously when projection patterns are separated by color. The colors used for projection may be essentially those of the camera's color pixels so that the color channels can be the primary colors of the raw camera image before pixel interpolation. Thus a single color image can provide two or more shifted projected patterns. A Bayer filter pattern of color pixels gives more resolution to the dominant green, than to blue and red. A CYGM or RGBE filter provides four colors with equal weight. It may be useful to project two color-separated patterns simultaneously and to use a color camera to separate the two pattern images. Acquiring two such color images with shifted patterns allows for the acquisition of four projected patterns on the object, and it has been found that having an additional pattern image over the minimum required (when object reflectivity properties are unknown) is useful for inspection. For example, using a Bayer-filter camera, one pattern can be in green, while the other can contain both blue and red. Some cameras have beam splitters to image the field of view through separate filters and separate image acquisition devices. It will be appreciated that a CCD-based image acquisition device or a CMOS-based imaging device may be used. Calibration of R(x,y) independently for each of the color channels may be required.

In addition to using spectral channels to acquire a plurality of pattern projection images simultaneously, it will be appreciated that polarization of light can also be used. Two projection systems with different polarized light can be used. Alternatively, a same projection system, for example, having a white light source can be split into two optical paths with orthogonal polarization states. Each path can be used to project a pattern, and either the two paths have separate projection optics, or they can be recombined before passing through the projection optics. Since CCD's with polarization filters for individual pixels are not commercially available, the imaging system can use a filter or polarization beam splitter with separate CCD's (or other image sensors) to obtain the images of the different patterns simultaneously.

Three or more different phase-shifted projected intensity patterns may be needed in order to calculate the phase of the point {x,y}:

φ(x,y)=kₓ·x+k_{y}·y+k_{z}·z(x,y) (2)

In the case of four phase steps (three shifts of π/2), the intensity equations take the following form:

$$\{ \begin{matrix} {I}_{a} ( x , y ) = R ( x , y ) \cdot [ 1 + M ( x , y ) \cdot Cos ( ϕ ( x , y ) ) ] \\ {I}_{b} ( x , y ) = R ( x , y ) \cdot [ 1 + M ( x , y ) \cdot Cos ( ϕ ( x , y ) + π / 2 ) ] \\ {I}_{c} ( x , y ) = R ( x , y ) \cdot [ 1 + M ( x , y ) \cdot Cos ( ϕ ( x , y ) + π ) ] \\ {I}_{d} ( x , y ) = R ( x , y ) \cdot [ 1 + M ( x , y ) \cdot Cos ( ϕ ( x , y ) + 3 π / 2 ) ]\end{matrix} \qquad ( 3 )$$

and the phase can be obtained as follows:

$$tan ( ϕ ( x , y ) ) = \frac{{I}_{d} ( x , y ) - {I}_{b} ( x , y )}{{I}_{a} ( x , y ) - {I}_{c} ( x , y )} \qquad ( 4 )$$

For moiré interferometry, the phase calculation is independent both from the target reflectance and the pattern modulation. Therefore the phase distributions of the reflections from object φ_{object}(x,y) and reference φ_{ref}(x,y) surfaces can be obtained independently for each point {x,y} and separately with time and with different illuminations. For example, the reference phase φ_{ref} can be calculated during preliminary calibration with a plane surface.

Moiré Interferometry uses the difference between the object and reference phases in order to measure the object height z(x,y) at each point {x,y}:

$$z ( x , y ) = \frac{1}{{k}_{z}} \cdot ( {ϕ}_{object} ( x , y ) - {ϕ}_{ref} ( x , y ) ) \qquad ( 5 )$$

The coefficient k_{z} represents the spatial grating frequency in the vertical (z) direction and can be obtained from system geometry or from calibration with an object of known height. In some embodiments, k_{z} is determined using the absolute height measurement, and then the value of z is determined with precision. In other embodiments, the value of z is first determined using an estimate of k_{z}, and once the absolute height is determined, then k_{z} is determined and then the more precise value of z is determined.

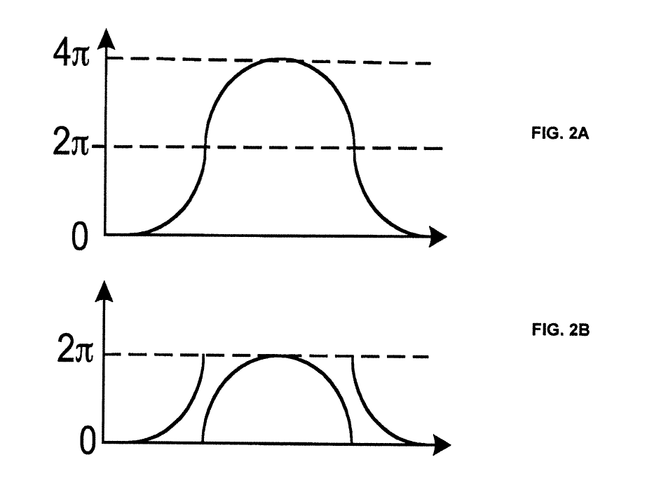

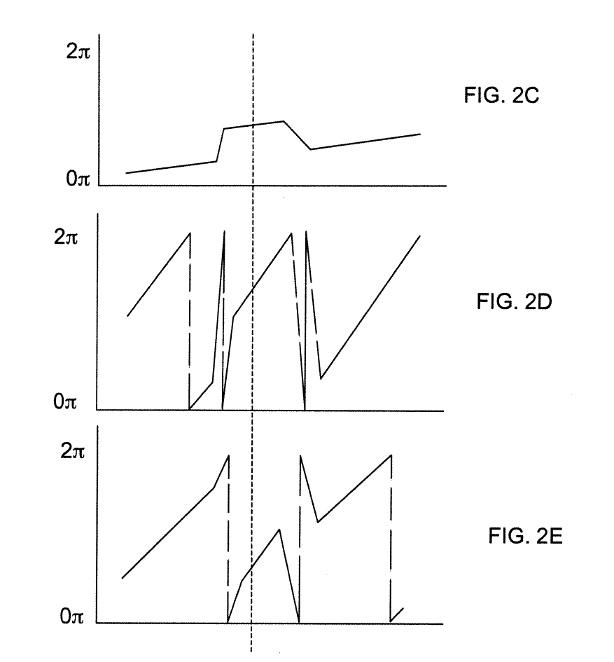

Due to the periodicity of the tan function in equation (4), the measured phase values are wrapped by 2π (as shown by FIGS. 2A and 2B). Referring to FIGS. 2A and 2B, FIG. 2A shows an example height profile of an object, where the height of the object extends between 0 and 2π. The precision available for the object profile in FIG. 2A is less susceptible to accurate resolution of the height of features on the object because the full dynamic range of the system is used to cover a relatively great height. Because phase profilometry systems generally cannot distinguish object heights separated by increments of 2π, the profile of the object in FIG. 2A will appear to the phase profilometry system as illustrated in FIG. 2B when the full phase range covers only half of the height of the object. For example, for such phase profilometry systems, 2.01π or 4.0π is indistinguishable from 0.01π. However, the precision of the system in FIG. 2B is better than that of FIG. 2A because each unit of phase resolves a smaller unit of height.

As illustrated in FIG. 2C, the pattern projected on the object can be arranged to be “low frequency” such that the range of phase variation from 0 to 2π is much greater than the object height. In this case, however, it is difficult to use the phase measurement to precisely determine height, even if phase order problems are resolved. For instance, height may be determined to the nearest 5 microns. This is similar to FIG. 2A. In FIG. 2D, a higher frequency pattern is used. While resolution is much better, for example in the order of 0.1 microns, the problem of phase order is present, as the phase jumps across the 0 to 2π boundary often as the object height varies.

In FIG. 2E, a different (slightly lower) high frequency pattern is used to obtain the illustrated height profile from FIG. 2E. As can be seen, the phase varies with height, but the phase values in FIGS. 2D and 2E are not the same across the object, due to the different modulation frequency applied to the pattern projected on the object.

As will be appreciated by observing the vertical dotted line passing through FIGS. 2C, 2D and 2E, at any point on the object, one can definitively determine the object height using any two of the three phase values. FIG. 2C has the ability to alone provide absolute object height with a precision sufficient to define which order of the higher frequency pattern of FIG. 2D or 2E are concerned. The accuracy of the higher frequency pattern in conjunction with the order resolution of the lower frequency pattern combine to provide an accurate height determination with a good height scale range.

In one embodiment, the projection of the lower frequency pattern (as illustrated in FIG. 2C) is done simultaneously with the projection of the higher frequency pattern. The lower frequency pattern is not shifted, while the higher frequency pattern is shifted with respect to the object. Images of the object are taken with the higher frequency pattern shifted, and the lower frequency pattern in the same position. The phase of the higher frequency pattern can be determined while the contribution from the lower frequency pattern is treated as background. The images are combined, normally added, to obtain a single image with the higher frequency pattern no longer appearing. For example, two images taken with the high frequency pattern projected on the object shifted by 180° can be simply added together to yield a single image. Other combinations are possible. The “background” low frequency pattern will appear in the resulting single image. This image can be analyzed to determine the height of the object using the second pattern, and in the case of the low frequency pattern, the absolute height is determined.

While in the embodiment just described, the projection system projects the two patterns along the same optical axis, in other embodiments, the patterns may be projected along different optical axes. As an example, the two projection optical axes and the imaging optical axis can be in a common plane. The imaging axis, for example, can be normal to the imaging stage with the two projection axes at a same angle from on opposite sides of the imaging axis. Simultaneous projection of a high frequency pattern along with a low frequency pattern is possible as in the previous embodiment.

For reasons explained below, the determination of object height using a pattern requires projecting the pattern in two to four positions on the object. Phase calculations may be made using the collected intensity values that effectively determine the object's light reflective properties R(x,y) in response to the grid or pattern projected onto the object. When the projection parameters in relation to the object are so calibrated, it is feasible to use the same projection system to project a low frequency pattern in a single position on the object to collect the lower accuracy absolute height determination. This is possible because the projection-system-dependent variables M(x,y) and the object-reflectivity-dependent variables R(x,y) are predetermined.

Alternatively, it will be seen that the two better precision object height profiles of FIGS. 2D and 2E can be used to determine the absolute object height, since the combination of phase values are unique to a predetermined absolute height within a much broader height range. Thus the order of 2π within which the absolute height falls can be determined without relying on a low frequency pattern.

In the above-described embodiments, absolute height of the object is resolved without reliance on any a priori assumption concerning object uniformity. In the case that an assumption is made that the object respects the condition of no height jumps greater than a half order of the projected pattern, however, it is possible to determine the relative object phase over the whole of the object. This technique may be referred to as unwrapping. With unwrapping, a phase order related discontinuity in determining the height of the object is avoided, however, without having an absolute phase reference the accuracy of the height determination is compromised when height is not a linear function of phase, as is normally the case with conventional light projection and camera imaging systems.

It will thus be appreciated that in some embodiments, the unwrapped relative phase of the object can be determined while the absolute height of the object is determined at one or more points, such that the absolute height of the object can be determined using the unwrapped relative phase of the object. This can be achieved optically by projecting a dot or line on the object (or a number of dots or lines) and imaging the projected dot or line in accordance with conventional profilometry techniques. When the projected pattern is a series of lines selected to be able to determine absolute height at various points over the object, unwrapping may be done as required only between known absolute height points. An absolute height determination of the object can also be achieved by non-optical means. For example, a CMM probe can be used to make contact with the object at one or more points to measure its absolute height. In some cases, ultrasound may also be applicable for absolute height measurement.

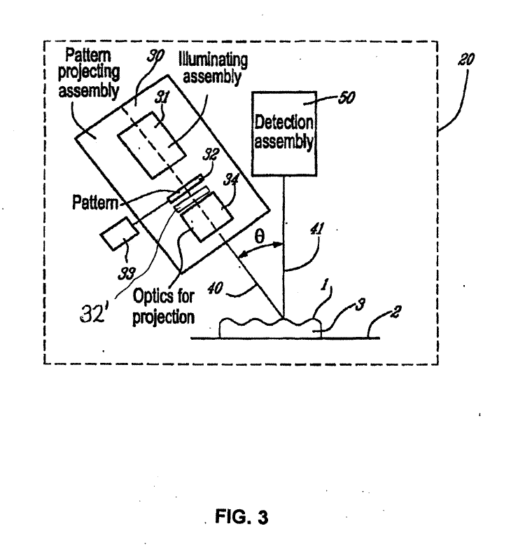

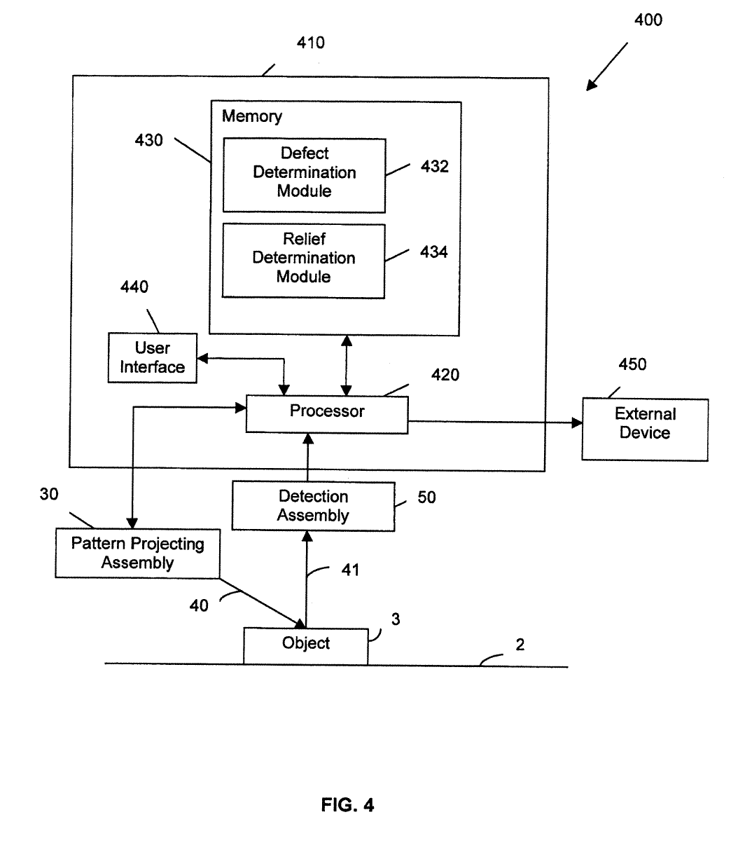

Turning now to FIGS. 3 and 4, a projection and detection system 20 for use in determining a height mapping of the object is shown. The projection and detection system 20 comprises a pattern projecting assembly 30 and a detection assembly 50. As show in FIG. 3, the pattern projecting assembly 30 is used to project onto the surface 1 of the object 3 a light intensity pattern having a given fringe contrast function M(x,y). The pattern projecting assembly 30 projects the intensity pattern along a projection axis 40 positioned at an angle θ with respect to a detection axis 41 of the detection assembly 50.

The detection assembly 50 is used to acquire the intensity values mathematically described by equation (3). The detection assembly 50 can comprise a charge coupled device (CCD) camera or other suitable image capture device. The detection assembly 50 can also comprise the necessary optical components, known to those skilled in the art, to relay appropriately the reflection of the intensity pattern from the object to the detection device.

The pattern projecting assembly 30 can comprise, for example, an illuminating assembly 31, a pattern 32, and projection optics 34. The pattern 32 is illuminated by the illuminating assembly 31 to generate a light intensity pattern for projection onto the object 3 by means of the projection optics 34. The pattern 32 can be a grating having a selected pitch value for generating an interference pattern in light waves propagated through the grating.

The characteristics of the intensity pattern impinging on the object 3 can be adjusted by tuning both the illuminating assembly 31 and the projection optics 34. A pattern displacement unit 33 is used to shift the pattern 32 (and thus the projected intensity pattern) relative to the object in a controlled manner. The pattern displacement unit 33 comprises a mechanical or electromechanical device for translating the pattern 32 orthogonally to the projection axis 40. This translation is precisely controlled by a computer system 410 (FIG. 4) to accomplish a predetermined phase shift in the projected light intensity pattern. Alternative ways of shifting the pattern 32 relative to the object 3 may include displacement of the object 3 and displacement of the pattern projection assembly 30.

The phase profilometry inspection system 20 in one embodiment has a pattern projection assembly 30 projecting a plurality of first light intensity patterns onto an object, namely a sinusoidal intensity modulation as described above with each first light intensity pattern being shifted with respect to each other first light intensity pattern. In addition to the shifted pattern 32, a low frequency pattern 32′ that is not shifted is projected simultaneously with the high frequency pattern 32. The detection assembly 50 images the plurality of first light intensity patterns with the “background” pattern 32′ on the object and determines a first height of the object. During the determination of the first height, the second pattern is essentially ignored, and the first height is determined within an order of the first light intensity pattern and does not resolve absolute height, as described above. The detection assembly includes an absolute object height determination unit combining the first height with at least one second object height measurement to provides absolute height determination of desired points of the object. The detection assembly 50 combines intensity data of the first light intensity patterns to provide intensity data related to the second pattern. The detection assembly 50 determines the second object height from the second pattern intensity data.

Referring in particular to FIG. 4, there is shown an object inspection system 400 comprising the projection and detection system 20 shown in FIG. 3. System 400 comprises a computer system 410 in communication with the projection and detection system 20 for performing inspection of object 3 (by relief determination). System 400 also performs a comparison of the object to an object model to determine whether to accept or reject the object or a product comprising the object.

System 400 is useful in high-speed inspection systems as part of a quality control step in a product manufacturing process. The inspection is applicable in particular to small objects having small height variations, for example such as electrical circuit components on a printed circuit board or balls in a ball grid array. Inspection using system 400 may be performed to determine whether an object is malformed or improperly positioned or oriented to accomplish its function. System 400 further comprises a communication link or output to an external device 450, such as a mechanical or electromechanical apparatus for directing accepted or rejected objects to appropriate destinations according to the manufacturing process.

Computer system 410 provides a control and analysis function in relation to projection and detection system 20, and for this purpose comprises a processor 420, a memory 430 and a user interface 440. The processor 420 controls pattern projecting assembly 30 and detection assembly 50 to cause one or more light intensity patterns to be projected onto object 3 and to capture reflected images of the object, respectively. Processor 420 executes computer program instructions stored in memory 430. Such program instructions may, for example, cause processor 420 to determine the relief of the object 3 based on the captured images and known or calculated system parameters according to a relief determination module 434 stored in memory 430.

Memory 430 comprises a non-volatile store, although it may also comprise a volatile memory portion, such as a cache or a random access memory (RAM) component. Memory 430 comprises a number of software modules comprising computer program instructions executable by processor 420 to accomplish various functions. Such software modules may include an operating system (not shown) and one or more modules for facilitating interaction with a user via user interface 440. Specific software modules comprised in memory 430 include the relief determination module 434 and a defect determination module 432. The defect determination module 432 is used to determine whether a defect exists in object 3, for example by comparing the determined relief of the object to a stored object model and, depending on the outcome of this comparison, determining whether or not a defect exists in the object.

Computer system 410 may be any suitable combination of computer software and hardware to accomplish the functions described herein. For example, computer system 410 may comprise a suitable personal computer (PC) or programmable logic controller (PLC). Alternatively, the computer system 410 may comprise one or more application specific integrated circuits (ASIC) and/or field programmable gate arrays (FPGA) configured to accomplish the described (hardware and/or software) functions. Although not shown in FIG. 4, computer system 410 comprises suitable communication interfaces for enabling communication between processor 420 and pattern projecting assembly 30 and detection assembly 50. Such communication interfaces may comprise analog to digital and/or digital to analog converters, as necessary. A similar communication interface is provided between processor 420 and external device 450, as necessary.

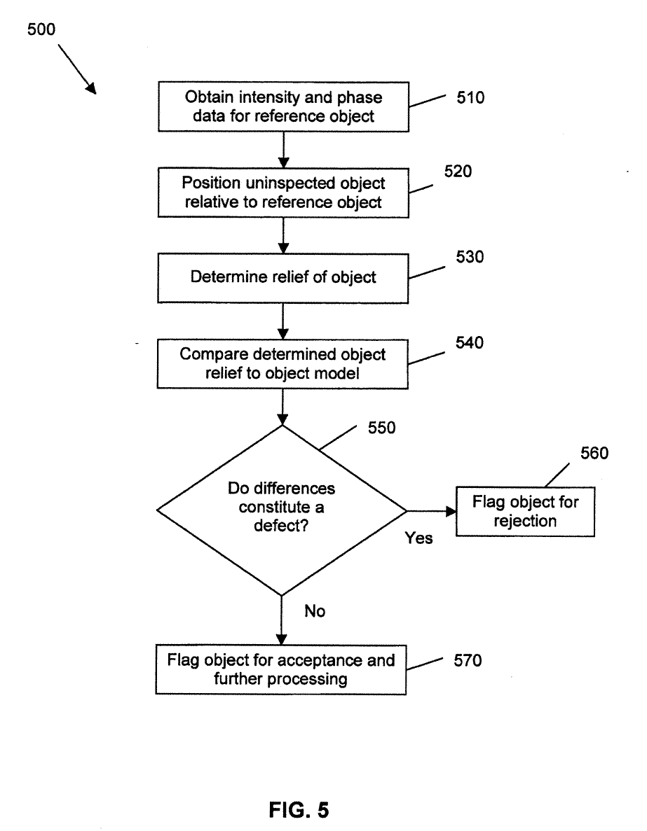

Referring now to FIG. 5, a method 500 of object inspection for use in product manufacturing is described in further detail. Method 500 may employ the object inspection system 400 shown in, and described in relation to, FIG. 4.

Method 500 begins at step 510, at which intensity and phase data for a reference object is obtained. This reference object may comprise reference surface 2, for example. Alternatively, the reference object may be an object closely resembling the object to be inspected, in an idealized form of the object. As a further alternative, the reference object may be a virtual object in the sense that it comprises a computerized model of the object, such as a computer aided design (CAD) model. In this alternative, the intensity and phase data may be theoretical data obtained based on the CAD model, rather than being measured at detection assembly 50.

Once the intensity and phase data is obtained for the reference object, it may be used to determine the relief of multiple objects under inspection, assuming that the object data is obtained using the same projection and detection parameters as those used to obtain the intensity and phase data for the reference object.

In one embodiment, step 510 may be performed by projecting three consecutive phase-shifted light intensity patterns onto the reference object and, for each projected light intensity pattern, capturing an image reflected from the reference object. Such sequential image capture of three phase-shifted images enables the solution of a system of three equations for three unknowns, thereby enabling calculation of the phase for each point (x,y) on the reference object corresponding to a pixel in the reflected image. Where the fringe contract function M(x,y) is known, this eliminates one of the unknowns and the phase information for the reference object may be calculated using only two captured images of respective phase-shifted light intensity patterns reflected from the reference object.

In step 520, object 3 is positioned relative to the reference object, if necessary (i.e. if the reference object is a physical object, such as reference surface 2). Object 3 may be a discrete component or it may form part of a product under inspection. Such a product may comprise a large number of objects similar to object 3. Alternatively, the entire product, with its many object-like surface features, may be considered to be the object 3 under inspection.

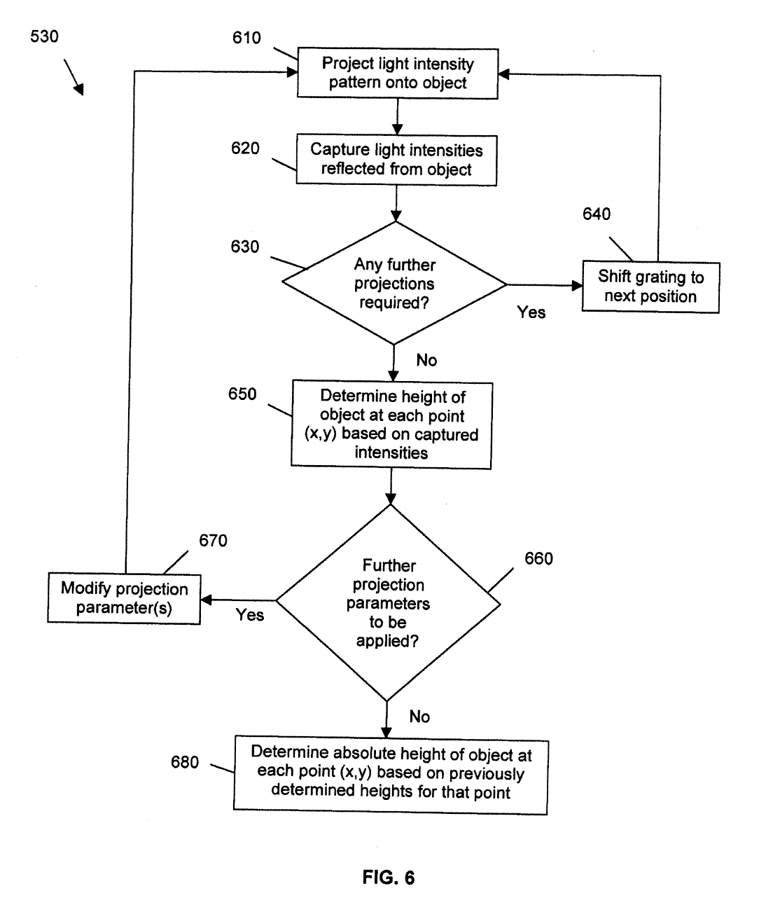

At step 530, the relief of the object 3 is determined. Performance of step 530 is described in further detail below, with reference to FIG. 6.

At step 540, the object relief determined at step 530 is compared to a predetermined object model. At step 550, any differences between the object relief and the object model arising from the comparison at step 540 are examined in order to determine whether such differences constitute a defect in the object. For example, where the determined differences between the object relief and the object model are within predetermined acceptable tolerances, it may be determined that such differences do not constitute a defect. On the other hand, differences outside of such predetermined tolerances may be considered to constitute a defect in the object.

If, at step 550, a defect is found in the object, then the object is flagged for rejection at step 560 and this is communicated to the external device 450 by processor 420. On the other hand, if the differences do not constitute a defect, the object is flagged at step 570 for acceptance and further processing according to the desired manufacturing process.

Referring now to FIG. 6, step 530, in which the relief of the object is determined, is described in further detail. Step 530 may also be described as a method of relief determination. The method of relief determination begins at step 610, in which pattern projecting assembly 30 is controlled by processor 420 to project a light intensity pattern onto the object 3. The light intensity pattern is projected according to certain environmental parameters, such as the angle between the projection access 40 and detection access 41, the distance of the pattern projecting assembly 30 from the object 3 and the position of the pattern 32, for example. Such environmental parameters are recorded by processor 420 in memory 430 for each projection of a light intensity pattern onto object 3 at step 610.

At step 620, light intensities are captured by the detection assembly 50 after reflection from the object 3, immediately following projection of the light intensity pattern at step 610.

At step 630, processor 420 determines whether any further projections of light intensity patterns are required in order to obtain enough intensity and phase data for use in determining the object relief. For example, steps 610 and 620 may be performed 2, 3 or 4 times (with respective phase-shifted projection patterns) to obtain the desired phase and/or intensity data.

If, at step 630, any further projections onto object 3 are required, then, at step 640, the projection grating (i.e. pattern 32) is shifted to a next position, so that the next light intensity pattern to be projected onto object 3 will be phase-shifted by a predetermined amount. Shifting of the projection grating is controlled by a signal transmitted from processor 420 to pattern displacement unit 33. Following step 640, steps 610 to 630 are repeated.

Once no further projections are required at step 630, processor 420 (executing relief determination module 434) determines a height of the object at each point based on the captured light intensities, at step 650. The heights of each point (x,y) are determined by computing the phase differences between object 3 and the reference object, where the phase differences are determined as a function of the light intensities captured at step 620 for the object (and at step 510 for the reference object, if applicable). The heights determined at step 650 for each point (x,y) are respective possible heights from among a plurality of such possible heights, each corresponding to phase shifts of 2π. Thus, in order to definitively determine the relief of the object 3, it will be necessary to determine which of the possible heights is the actual (absolute) height at each point (x,y).

At step 660, processor 420 determines whether any further projection parameters are to be applied, for example in order to obtain further images of the object at different projection parameters to aid in determining which of the possible heights of each point on the object is the actual height.

If further projection parameters are to be applied, then at step 670, the projection parameters are modified, projection and detection system 20 is reconfigured by processor 420, as necessary, and steps 610 to 660 are repeated, as necessary. Example projection parameters that may be modified at step 670 include the angular separation θ between the projection axis 40 and the detection axis 41, the frequency modulation of the projected light intensity pattern and the distance between the pattern projecting assembly 30 and the object 3. In one exemplary embodiment, steps 610 to 660 only need to be repeated once with one modified projection parameter in order to enable the actual height of the object at each point (x,y) to be determined. However, it is possible that for increased accuracy and/or robustness of data, steps 610 to 660 may be repeated more than once.

If no further projection parameters are to be applied at step 660, for example because no further iterations of steps 610 to 650 are required, then at step 680, processor 420 determines the absolute height of the object at each point (x,y) based on the heights determined at different iterations of step 650. Depending on the different projection parameters used to obtain each series of captured light intensities in steps 610 to 640, different heights may be determined for the object at each respective point (x,y) at step 650. Step 680 determines the absolute height of the object from the different heights determined at step 650 by analyzing the determined heights and the respective projection parameters used to obtain them, as described below in further detail.

According to certain embodiments, separate iterations of steps 610 to 650 may be performed, where the projection parameter modified at step 670 is the frequency modulation applied to the light intensity pattern projected onto the object at step 610. Thus, in a first iteration of steps 610 to 650, the projected light intensity pattern is modulated by a first frequency and at least two phase shifted reflected intensity patterns modulated by the first frequency are captured through two iterations of steps 610 to 620. If the fringe contrast function M(x,y) is already known, then the two captured reflections of the light intensity patterns are sufficient to determine a possible height for each point (x,y), at step 650. This possible height will be somewhere between 0 and 2π, while other possible heights of the object at that point will be at different orders of 2π. Without further information, it is not possible to know what is the actual (absolute) height (i.e. to distinguish which of the plurality of possible heights is the actual height).

Accordingly, it is necessary to obtain information to corroborate one of the possible heights determined at the first iteration of step 650. Thus, in the second iteration of steps 610 to 650, a second frequency is used to modulate the projected light intensity pattern at step 610 and at least one reflected light intensity pattern is captured at step 620. If only the frequency modulation of the projected light intensity pattern is changed between steps 610 to 650, then only one reflected light intensity pattern needs to be captured at step 620 in the second iteration of steps 610 to 650, as the system unknowns will have been determined in the first iteration.

When step 650 is performed for the second frequency modulation, at least one second possible height of the object is determined for each point (x,y). This at least one second possible height for each point (x,y) of the object is compared to the first possible heights for the respective points determined at the first iteration of step 650. Depending on the order of 2π in which one of the second possible heights matches up with one of the first possible heights for the same point, this will determine the actual height of the object at that point.

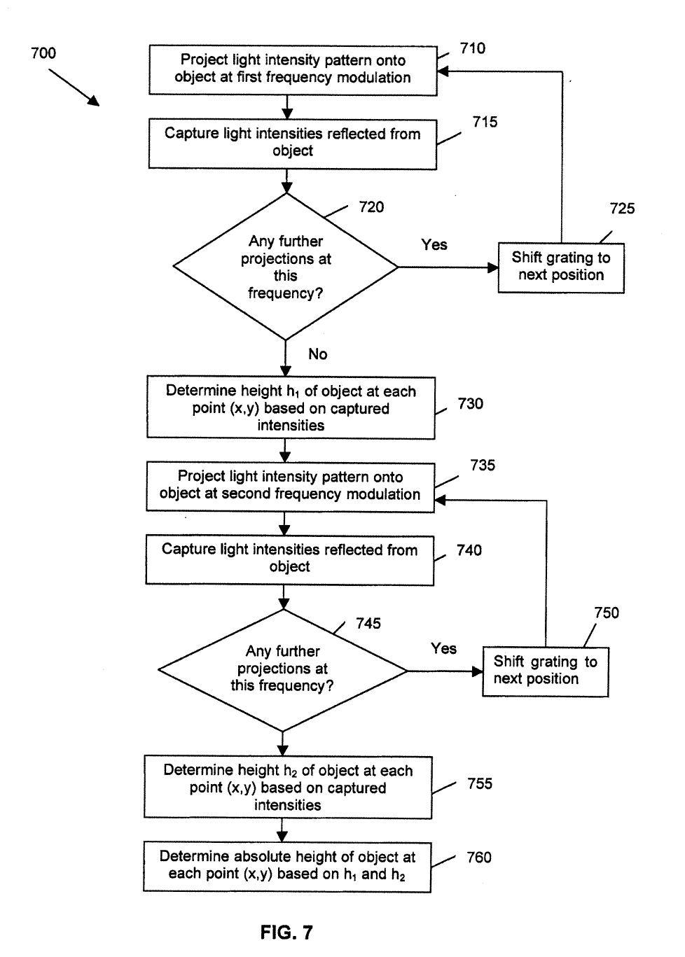

Referring now to FIG. 7, a specific embodiment of the method of FIG. 6 is described and designated by reference numeral 700. Method 700 begins at step 710 and is performed in the manner described above in relation to step 610. Similarly, steps 715, 720 and 725 are performed in a manner similar to corresponding steps 620, 630 and 640 described above in relation to FIG. 6. The main difference is that steps 710 to 725 are performed for a projected light intensity pattern at a first frequency modulation. Two to four iterations of steps 710 to 725 may be performed in order to satisfy the system requirements for determining a first height H₁ of the object at each point (x,y), at step 730. The height H₁ determined at step 730 for each point is one possible height of the object at the respective point based on the captured intensities of the reflected light intensity pattern at the first frequency modulation.

Following step 730, steps 735, 740, 745, 750, 755 are performed in a similar manner to the performance of corresponding steps 710, 715, 720, 725 and 730, but by modulating the projected light intensity pattern with a second modulation frequency to determine a second possible height H₂ of the object at each point (x,y). The heights H₂ of the object at points (x,y) are likely to be different to the previously determined heights H₁ for the same points because of the different frequency modulation applied to the projected light intensity pattern at step 35, for which light intensities were captured at step 740. In order for heights H₁ and H₂ to be different for a given point (x,y), the first and second modulation frequencies must be out of phase and must not be frequency multiples of each other. The first and second modulation frequencies may, in one embodiment, be close to each other, for example between 5 and 40% of each other. According to another embodiment, the first and second modulation frequencies are different by at least an order of magnitude.

For phase profilometry systems, the lower the modulation frequency, the larger the range of heights that can be determined but the lower the spatial resolution of heights within that range. On the other hand, the higher the modulation frequency, the greater the spatial resolution but the smaller the range. Thus, a higher frequency can be used as the first modulation frequency at step 710 and a lower frequency can be used as the second modulation frequency at step 735, or vice versa, to determine the height of the object at each point (x,y) within a large height range (using the lower frequency) but with greater precision (using the higher frequency), thereby enabling processor 420 to determine the absolute height of the object at each point (x,y), at step 760.

According to one embodiment, method 700 may be performed by capturing three reflected light intensity patterns at a first frequency and three light intensity patterns at a second frequency that is lower than the first modulation frequency. Alternatively, the first modulation frequency may be lower than the second modulation frequency. The first and second possible heights of the object for each point (x,y) are determined separately based on their respective modulation frequencies and the absolute height is determined based on the first and second possible heights. In an alternative embodiment, one reflected light intensity pattern(s) is/are captured for the second modulation frequency. In a further alternative embodiment, as few as two reflected light intensity patterns may be captured for the first modulation frequency, where the fringe contrast function M(x,y) is known. These latter two embodiments may be combined as a further embodiment.

While the above description provides example embodiments, it will be appreciated that some features and/or functions of the described embodiments are susceptible to modification without departing from the spirit and principles of operation of the described embodiments. Accordingly, the described embodiments are to be understood as being illustrative and non-limiting examples of the invention, rather than being limiting or exclusive definitions of the invention.

1. A method of manufacturing a product comprising an object, the method comprising inspecting said object including determining a relief of said object and rejecting or accepting said product using said relief, said determining said relief comprising combining a first object height determination resulting from a projection and imaging of a plurality of first light intensity patterns onto the object, each first light intensity pattern being shifted with respect to each other first light intensity pattern and modulated by a first modulation frequency, wherein said first object height determination does not resolve absolute height, with a second object height determination, wherein said combining provides absolute height determination of desired points of said object.

2. The method of claim 1, wherein said determining said relief comprises:
a) projecting said plurality of first light intensity patterns onto the object;
b) capturing first reflected light intensities reflected from the object for each projected first light intensity pattern;
c) determining for each of at least some pixels of an image of the object a first height of the object based on reference information and the first reflected light intensities;
d) projecting at least one second light intensity pattern onto the object, the at least one second light intensity pattern being modulated by a second modulation frequency different from the first modulation frequency;
e) capturing second reflected light intensities reflected from the object for each projected second light intensity pattern;
f) determining for at least one of said at least some pixels a second height based on the reference information and the second reflected light intensities;
g) determining a relief of the object based on the first and second heights for the at least some pixels.

3. The method of claim 2, wherein said second height is determined for all of said at least some pixels, and the second modulation frequency is less than the first modulation frequency.

4. The method of claim 2, wherein said second modulation frequency is selected to allow for absolute height determination while said first modulation is selected to allow for precision height determination.

5. The method of claim 4, wherein said second light intensity pattern is projected simultaneously with said first light intensity pattern, said second light intensity pattern remaining in the same position while said first light intensity pattern is shifted, steps (b) and (e) are performed together, and step (f) comprises combining intensity values to remove a variation due to said first modulation frequency and determining an absolute height of said object from a phase of said second light intensity pattern.

6. The method of claim 5, wherein said second height is determined for all of said at least some pixels.

7. The method of claim 2, wherein the plurality of first light intensity patterns comprise at least three first light intensity patterns, and the at least one second light intensity pattern comprises one intensity pattern, said second height being determined using object reflectivity parameters determined from said at least three first light intensity patterns.

8. The method of claim 2, wherein the at least one second light intensity pattern comprises a plurality of second light intensity patterns.

9. The method of claim 8, wherein the plurality of second light intensity patterns comprise at least three light intensity patterns.

10. The method of claim 2, wherein the second light intensity pattern is a step function comprising one or more lines or dots, step (c) comprises:
establishing an object topology jump threshold between neighboring pixels less than one half of one phase order of said first light intensity pattern;
determining when said first height crosses a phase order of said first light intensity pattern from one of said at least some pixels to another;
adding to said first height of the object a phase order value, and
step (g) comprises adjusting said first height by an absolute height value determined in step (f).

11. The method of claim 2, wherein said second height is determined for all of said at least some pixels, and steps a) and d) comprise projecting the first and second light intensity patterns onto the object from the same position and at the same angle.

12. The method of claim 7, wherein said second height is determined for all of said at least some pixels, and the at least one second light intensity pattern comprises at least three second light intensity patterns.

13. The method of claim 12, wherein step a) comprises projecting the first light intensity patterns onto the object at a first angle and step d) comprises projecting the second light intensity patterns onto the object at a second angle different from the first angle.

14. The method of claim 12, wherein step a) comprises projecting the first light intensity patterns onto the object from a first position and step d) comprises projecting the second light intensity patterns onto the object from a second position different from the first position.

15. The method of claim 2, wherein said second height is determined for all of said at least some pixels, and the first and second modulation frequencies differ by at least an order of magnitude.

16. The method of claim 2, wherein said second height is determined for all of said at least some pixels, and the first and second modulation frequencies differ by less than an order of magnitude.

17. The method of claim 16, wherein the second modulation frequency is within 40% of the first modulation frequency.

18. The method of claim 1, wherein said second height determination is non-optical.

19. The method of claim 1, wherein said first light intensity patterns comprise at least two patterns projected simultaneously with different colors and imaged simultaneously with a color imaging system.

20. The method of claim 1, wherein said first light intensity patterns are projected using a digital image projector.

21. A phase profilometry inspection system comprising:
a pattern projection assembly projecting a plurality of first light intensity patterns onto an object, each first light intensity pattern being shifted with respect to each other first light intensity pattern and modulated by a first modulation frequency;
a detection assembly imaging said plurality of first light intensity patterns on the object and determining a first height of the object, wherein said first height is determined within an order of said first light intensity pattern and does not resolve absolute height; and
an absolute object height determination unit combining said first height with at least one second object height measurement to provides absolute height determination of desired points of said object.

22. The system of claim 21, wherein the pattern projection system further projects a second light intensity pattern onto the object, and said detection assembly further detects said second light intensity pattern to obtain said at least one second object height measurement.

23. The system of claim 22, wherein said second pattern having a longer period than said first pattern, said first pattern providing good height resolution while said second pattern provides essentially absolute height determination.

24. The system of claim 23, wherein the pattern projection system projects said second pattern without shift simultaneously with said first pattern, said detection assembly combining intensity data of said first light intensity patterns to provide intensity data related to said second pattern, said detection assembly determining said second object height from said second pattern intensity data.
